(19) United States
(12) Patent Application Publication
(10) Pub. No.: US 2009/0216739 A1
(43) Pub. Date: Aug. 27, 2009

(54) BOOSTING EXTRACTION ACCURACY BY HANDLING TRAINING DATA BIAS

(75) Inventors: Alok S. Kirpal, Bangalore (IN); Meghana Kshirsagar, Bangalore (IN)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/036,079

(22) Filed: Feb. 22, 2008

(51) Int. Cl. G06F 7/10; G06F 17/30

(52) U.S. Cl. 707/5; 707/102; 707/E17.015; 707/E17.108

(57) ABSTRACT

Methods and apparatus are described for use with information extraction techniques based on sequential models. Additional statistics are maintained during inference and employed to boost the accuracy of the extraction algorithm and mitigate the effects of training bias.

### BACKGROUND OF THE INVENTION

The present invention relates to the extraction of information from sequential data and, in particular, to techniques for improving the performance of extraction techniques affected by training data bias.

A variety of machine learning models are employed to label or parse sequential data such as, for example, natural language text, biological sequences, and web pages. The accuracy of such models relies heavily on the quality of the training data. Unfortunately, given the scope of variability of the sequential data for which such models are employed, it is not possible to provide a sufficient amount of training data such that the models actually experience representative data before deployment. This problem, known as training data bias, can significantly undermine the accuracy with which such models evaluate sequential data. This is particularly true in cases where the desire is to extract particular attributes or parameters of interest from such data.

### SUMMARY OF THE INVENTION

According to the present invention, various techniques are provided for improving the performance of information extraction algorithms which conventionally suffer from training bias. According to a specific embodiment, methods and apparatus are provided for extracting information from sequential data. The sequential data include a plurality of sequentially arranged tokens. A plurality of label sequences is generated with reference to the sequential data and a sequential model. Each label sequence includes a plurality of attribute labels. At least some of the attribute labels correspond to attributes of interest. The attribute labels in each label sequence are sequentially arranged and correspond to the tokens of the sequential data. An output sequence is generated using selected ones of the attribute labels from different ones of the label sequences. Each of the selected attribute labels corresponds to one of the attributes of interest. Each selected attribute label occupies a same position in the output sequence as in a corresponding one of the label sequences. A representation is generated of selected ones of the tokens corresponding to the selected attribute labels.

According to another specific embodiment, methods and apparatus are provided for presenting information extracted from sequential data. The sequential data include a plurality of sequentially arranged tokens. Presentation of a representation of selected ones of the tokens in a user interface is facilitated. The selected tokens correspond to selected ones of a plurality of attribute labels. Each selected attribute label corresponds to one of a plurality of attributes of interest and was selected for inclusion in an output sequence from a corresponding one of a plurality of label sequences. Each selected attribute label occupied a same position in the output sequence as in the corresponding label sequence. The label sequences were generated with reference to the sequential data and a sequential model. Each label sequence included at least some of the plurality of attribute labels. The attribute labels in each label sequence were sequentially arranged and corresponded to the tokens of the sequential data.

A further understanding of the nature and advantages of the present invention may be realized by reference to the remaining portions of the specification and the drawings.

### BRIEF DESCRIPTION OF THE DRAWINGS

FIG. 1 is a flowchart illustrating operation of an information extraction algorithm according to a specific embodiment of the invention.

FIG. 2 is a flowchart illustrating operation of an information extraction algorithm according to another specific embodiment of the invention.

FIG. 3 is a simplified network diagram illustrating a computing context in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The present invention relates to the field of information extraction. The techniques described herein relate to statistical models and, in particular, sequential models. Some examples of such techniques make use of Conditional Random Fields (CRFs). However the techniques of the invention may be generalized to any sequential models used for information extraction. Examples of other sequential models suitable for use with the present invention include, but are not limited to, Hidden Markov Models (HMMs), and Maximum Entropy Markov Models (MEMMs). In addition, despite references below to extraction of information from web pages, embodiments of the present invention may be employed to extract information from a wide variety of sequential data. The invention should therefore not be limited because of references herein to specific examples of sequential models or types of data.

One example of a type of sequential data to which techniques of the invention may be applied is a web page. As is well known, a web page is represented using HyperText Markup Language (HTML) which is essentially a tree-like structure in which the data representing the content in the web page reside at the leaf nodes of the structure. These leaf nodes correspond to a sequence of data tokens to which a sequential model may be applied. Examples of the invention will now be described with reference to a specific type of web page—a product page in which, for example, information is presented by an online merchant regarding the nature of the product and related commercial terms. However, it should be understood that embodiments of the present invention which relate to the extraction of information from web pages may be readily applied to any content class, e.g., news, travel, video, jobs, etc. It should also be understood that, depending on the nature of the content and the purpose of the information extraction, the attributes of interest will vary considerably.

Yahoo!® Shopping aggregates product information from all over the Web. To accomplish this, Yahoo!® crawls shopping web sites and from each of these identifies products pages. Using information extraction techniques designed in accordance with the invention, Yahoo!® then identifies key attributes from each product page which define the associated product, e.g., product title, product image, product price, product description, etc. The extracted information, along with links to the sellers' sites, is then made available to consumers conducting product searches in the Yahoo!® network. Other classes of commercial content, e.g., travel services, are aggregated and presented in a similar manner. As will be understood, the key attributes of interest will typically depend on the nature of the sequential data from which the attributes are to be extracted.

According to various embodiments, the information extraction technique and the associated statistical model used to collect such key attributes is trained offline on samples of the type of sequential data for which the extraction technique is intended. The training data are annotated to identify the attributes of interest. So, for example, where the sequential data are product pages, attributes like title, price, image, and description are identified and labeled as such. However, as noted above, the variability of actual data on the Web is such that it is not conventionally feasible to provide a sufficient amount of training data that is actually representative. This is further exacerbated by the costs associated with the labor intensive task of annotating the training data. Therefore, according to various embodiments of the invention, the statistical model is supplemented with one or more additional techniques to boost operational efficiency.

According to a specific embodiment, and referring again to the product web page example, the attributes of interest are product title, product price, product image, and product description. Pages of training data are annotated with these labels as discussed above. All other objects or tokens in the product page which do not correspond to these attributes of interest are labeled “noise.” As will be understood, this generally results in a large proportion of the tokens for a given page being labeled as noise, and a relatively small proportion being labeled as information of interest.

An extraction algorithm operating in accordance with a sequential model (e.g., a CRF model) evaluates and assigns one of the possible labels (e.g., title, price, image, description, noise, etc.) to each token associated with the web page. Because of the predominance of noise during training, it is likely that output sequences which are all or mostly noise may have high confidence levels associated with them and that, as a result, a large proportion of the output sequences do not accurately identify the attributes of interest. Therefore, and according to various embodiments, additional statistics are maintained during inference to boost the accuracy of the extraction algorithm, i.e., improve the coverage over the attributes of interest.

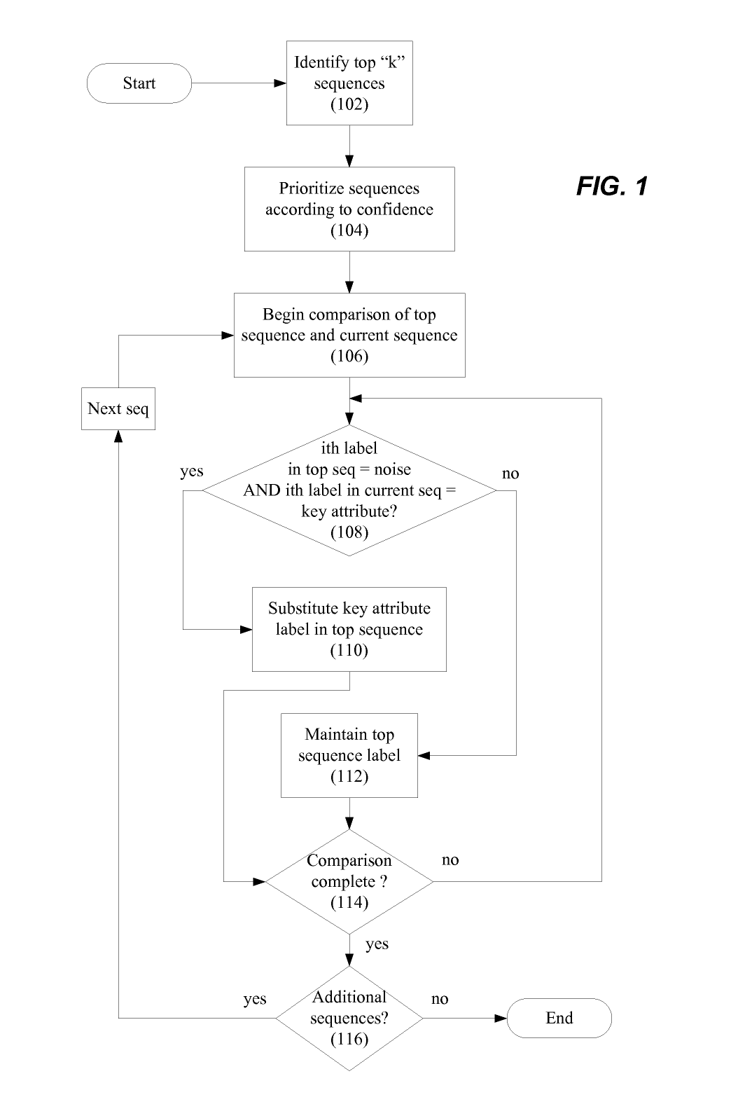

According to one class of embodiments, an example of which is illustrated in the flowchart of FIG. 1, instead of identifying only the output label sequence having the highest level of confidence, a number of label sequences, referred to herein as the top “k” sequences, having the highest confidence levels are identified (102). The sequences are prioritized according to the confidence level associated with each, with the top sequence having the highest confidence level, and the k^{th} sequence having the lowest (104).

The best value for k may depend on the type of data being subjected to the extraction algorithm. If k is set too high, there is a danger of including labels from sequences having very low confidence levels. On the other hand, if k is set too low, the top k sequences may not include at least one occurrence of a given attribute of interest. According to a specific embodiment, k=5 yields a significant improvement in accuracy for an extraction algorithm using a CRF model to extract product data from product web pages.

A position-by-position comparison of the top sequence and the second sequence is undertaken (106). At each position where the top sequence identifies a token as noise, but the second sequence identifies the same token as an attribute of interest (108), the label for that position in the second sequence is substituted for the noise label in the top sequence (110). If, however, the higher-confidence sequence includes a label for an attribute of interest at a particular position, that label is maintained (112).

When the position-by-position comparison and substitution is complete for the top two sequences (114), if there are any additional sequences (116), the process is repeated using the revised sequence and each successive sequence. Otherwise, the process ends with an output sequence which more accurately represents the information of interest in the page than an output sequence generated according to previous techniques.

According to some embodiments, additional constraints may be introduced to further enhance the accuracy of the extraction algorithm. For example, if it is known that there is likely to only be a single instance of a particular attribute of interest, e.g., product title or price, only a single substitution might be allowed. In such a case, where the higher confidence sequence has a noise label at a given position and the sequence to which it is being compared has a label for an attribute of interest at that same position, a substitution will only be made where the higher confidence sequence does not already contain that label at any position.

The “top k” approach described above results in significant improvement in the accuracy of information extraction algorithms which employ sequential models. However, it is possible that an attribute of interest may not appear in the top k sequences. Therefore, in some cases, an additional technique may be employed as an alternative or in combination to improve coverage across the attributes of interest.

For every position in the sequential data being analyzed, a conventional extraction algorithm tries to assign a label based on the probability that the token at that position corresponds to that label. This probability is typically computed with reference to the features of the token itself, as well as the context around the token, e.g., labels assigned to immediately preceding tokens in the sequence. According to another class of embodiments, additional probabilities are maintained for each position in the sequence, as well as the best possible sequence for each attribute.

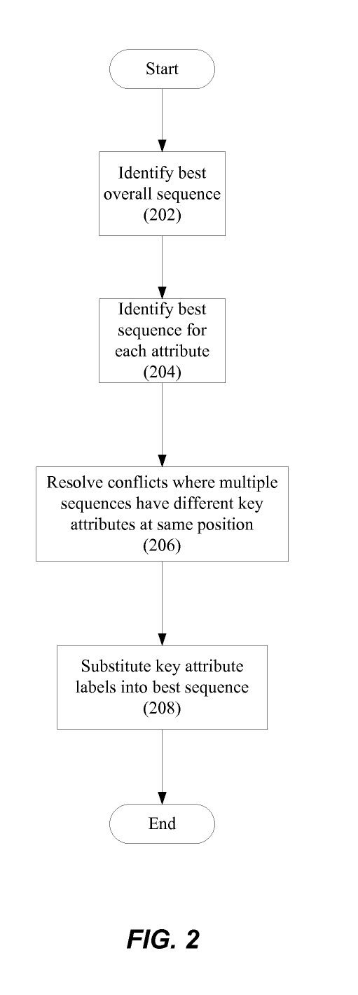

According to a specific embodiment, an example of which is illustrated in the flowchart of FIG. 2, the best possible sequence, i.e., the sequence with the highest confidence, is identified (202). For each attribute, the highest confidence sequence which includes that attribute is also maintained (204). In some cases, one or more of these may correspond to the best overall sequence, i.e., the highest confidence sequence might include one or more of the attributes of interest. In addition, a single sequence might be the highest confidence sequence for multiple attributes.

If two different key attribute labels appear at the i^{th} position in different sequences, the attribute label from the sequence having the higher confidence level will be placed in the i^{th} position in the output sequence. In such a case, the position of the attribute label in the lower confidence sequence may be derived with reference to the next highest confidence sequence including that label (206).

The output sequence of the extraction algorithm is derived with reference to the best overall sequence and the highest confidence sequence for each attribute by substituting key attribute labels from the highest confidence sequence in which each occurs into the best overall sequence at the same position at which they appear in their original sequence (208). So, for example, if the attribute label “product price” appears at the i^{th} position in the highest confidence sequence which includes that label, the “product price” label is placed at the i^{th} position of the best overall sequence (which will ultimately be the output sequence when all substitutions are made). If the highest confidence sequence in which the “product price” label appears is also the best overall sequence, then no substitution is necessary for this attribute.

According to a specific embodiment, at each position and for every attribute, the best assignment of labels to the sequence so far is maintained by selecting the best sequence corresponding to the higher of:

Max of {prob(seq. for attr. A at pos i−1)*prob(token_i is not A)} and

Max of {prob(top kth seq. till i−1 without attr A.)*prob(token_i is A)}

It should be noted that the two classes of embodiments described herein may be employed separately or in combination with each other to enhance the accuracy of information extraction algorithms which employ sequential models.

The accuracy boost made possible by the present invention may confer significant advantages in a wide variety of contexts. For example, specific embodiments enable the extraction of large volumes of high quality data from web pages or text fragments, and/or increases in the volume of data extracted without a corresponding reduction in the quality of the extracted data.

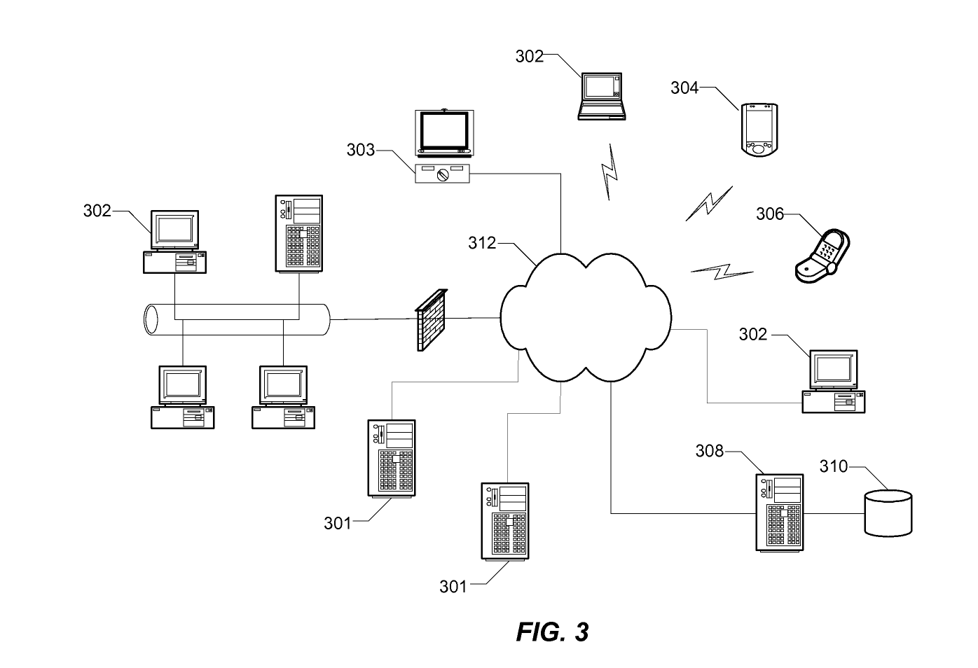

Embodiments of the present invention may be employed to extract information from sequential data in any of a wide variety of computing contexts. For example, as illustrated in FIG. 3, implementations are contemplated in which a population of users interacts with web sites 301 via a diverse network environment using any type of computer (e.g., desktop, laptop, tablet, etc.) 302, media computing platforms 303 (e.g., cable and satellite set top boxes and digital video recorders), handheld computing devices (e.g., PDAs) 304, cell phones 306, or any other type of computing or communication platform.

And according to various embodiments, sequential data processed in accordance with the invention may be collected using a wide variety of techniques. For example, collection of sequential data representing web pages from web sites 301 may be accomplished using any of a variety of well known mechanisms such as, for example, any type of web crawler, process, or bot.

Once collected, the sequential data may be processed in some centralized manner. This is represented in FIG. 3 by server 308 and data store 310 which, as will be understood, may correspond to multiple distributed devices and data stores. The invention may also be practiced in a wide variety of network environments including, for example, TCP/IP-based networks, telecommunications networks, wireless networks, etc. These networks are represented by network 312. The information extracted from the sequential data may then be provided to users in the network via the various channels with which the users interact with the network.

In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, the present invention may be used to enhance information extraction in a variety of domains. For example, the techniques described herein may be used in speech recognition applications in which the sequential data is captured speech, and the attributes of interest are specific words or phrases in one or more languages of interest. Bioinformatics is another domain in which embodiments of the invention may be employed. For example, the sequential data could be a genome and the attributes of interest particular gene sequences. Part-Of-Speech (POS) tagging is yet another domain in which sequential models may be employed with embodiments of the invention to identify the POS of a word. In this domain, the sequential data could be paragraphs of text, and POS tags like Noun, Verb, Adverb, etc., correspond to the attributes of interest. In general, information extraction techniques applied to virtually any type of sequential data may be enhanced in accordance with the present invention.

Moreover, it should be understood that even within particular domains, implementations of the present invention may vary significantly without departing from the scope of the invention. For example, where embodiments of the invention are applied to the extraction of information from web pages, it should be noted that, depending on the nature or class of the content of the web pages and/or the goal of the extraction, the attribute schema may vary significantly. For example and as described above, where the web page content relates to product information, and the purpose of extraction is to provide relevant product information to consumers, the attributes of interest might include product title, product image, product price, product description, etc. On the other hand, where the web page content relates to job listings, and the purpose of the extraction is to provide relevant listings to job seekers, the attributes of interest might include job title, job description, location, salary, etc. In yet another example, where the web page content includes video clips, the attributes of interest might include a video title, a still image from the video, a brief description, a rating, etc. As will be understood, the classes of web page content to which embodiments of the present invention may be applied and the attribute schema which may be appropriate for a given application are virtually limitless.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for extracting information from sequential data, the sequential data comprising a plurality of sequentially arranged tokens, the method comprising:
generating a plurality of label sequences with reference to the sequential data and a sequential model, each label sequence comprising a plurality of attribute labels, at least some of the attribute labels corresponding to attributes of interest, the attribute labels in each label sequence being sequentially arranged and corresponding to the tokens of the sequential data;
generating an output sequence using selected ones of the attribute labels from different ones of the label sequences, each of the selected attribute labels corresponding to one of the attributes of interest, each selected attribute label occupying a same position in the output sequence as in a corresponding one of the label sequences from which the selected attribute label originated; and
generating a representation of selected ones of the tokens corresponding to the selected attribute labels.

2. The method of claim 1 wherein each label sequence has a confidence level associated therewith, and wherein the plurality of label sequences correspond to the k highest confidence levels, where k is a natural number which is fewer than a total number of sequences generated for the sequential data.

3. The method of claim 1 wherein the plurality of label sequences includes a highest confidence sequence for each of the attributes of interest.

4. The method of claim 1 wherein the sequential model comprises one of a Conditional Random Field model, a Hidden Markov model, or a Maximum Entropy Markov model.

5. The method of claim 1 wherein the sequential data represents one of a web page, a portion of a genome, recorded speech, or text.

6. The method of claim 1 further comprising transmitting the representation of the selected tokens in response to a search query relating to at least one of the attributes of interest.

7. The method of claim 1 wherein each label sequence has a confidence level associated therewith, and wherein the confidence level associated with the label sequence from which each of the selected attribute labels is selected for inclusion in the output sequence is highest among all sequences including the corresponding selected attribute label.

8. A computer program product for extracting information from sequential data, the sequential data comprising a plurality of sequentially arranged tokens, the computer program product comprising at least one computer-readable medium having computer program instructions stored therein configured to cause at least one computing device to:
generate a plurality of label sequences with reference to the sequential data and a sequential model, each label sequence comprising a plurality of attribute labels, at least some of the attribute labels corresponding to attributes of interest, the attribute labels in each label sequence being sequentially arranged and corresponding to the tokens of the sequential data;
generate an output sequence using selected ones of the attribute labels from different ones of the label sequences, each of the selected attribute labels corresponding to one of the attributes of interest, each selected attribute label occupying a same position in the output sequence as in a corresponding one of the label sequences from which the selected attribute label originated; and
generate a representation of selected ones of the tokens corresponding to the selected attribute labels.

9. The computer program product of claim 8 wherein each label sequence has a confidence level associated therewith, and wherein the plurality of label sequences correspond to the k highest confidence levels, where k is a natural number which is fewer than a total number of sequences generated for the sequential data.

10. The computer program product of claim 8 wherein the plurality of label sequences includes a highest confidence level sequence for each of the attributes of interest.

11. The computer program product of claim 8 wherein the sequential model comprises one of a Conditional Random Field model, a Hidden Markov model, or a Maximum Entropy Markov model.

12. A computer-implemented method for presenting information extracted from sequential data, the sequential data comprising a plurality of sequentially arranged tokens, the method comprising facilitating presentation of a representation of selected ones of the tokens in a user interface, the selected tokens corresponding to selected ones of a plurality of attribute labels, each selected attribute label corresponding to one of a plurality of attributes of interest and having been selected for inclusion in an output sequence from a corresponding one of a plurality of label sequences, each selected attribute label having occupied a same position in the output sequence as in the corresponding label sequence from which the selected attribute label originated, the label sequences having been generated with reference to the sequential data and a sequential model, each label sequence having included at least some of the plurality of attribute labels, the attribute labels in each label sequence having been sequentially arranged and having corresponded to the tokens of the sequential data.

13. The method of claim 12 wherein the sequential data represented one of a web page, a portion of a genome, recorded speech, or text.

14. The method of claim 12 wherein presentation of the representation of the selected tokens is facilitated in response to a search query relating to at least one of the attributes of interest.

15. At least one computer-readable medium having a data structure stored therein representing information extracted from sequential data, the sequential data comprising a plurality of sequentially arranged tokens, the data structure comprising an output sequence comprising selected ones of a plurality of attribute labels, each selected attribute label corresponding to one of a plurality of attributes of interest and having been selected for inclusion in the output sequence from a corresponding one of a plurality of label sequences, each selected attribute label occupying a same position in the output sequence as in the corresponding label sequence from which the selected attribute label originated, the label sequences having been generated with reference to the sequential data and a sequential model, each label sequence having included at least some of the plurality of attribute labels, the attribute labels in each label sequence having been sequentially arranged and having corresponded to the tokens of the sequential data, wherein the output sequence is configured to facilitate presentation of a representation of selected ones of the tokens in a user interface, the selected tokens corresponding to the selected attribute labels.

16. The at least one computer-readable medium of claim 15 wherein each label sequence had a confidence level associated therewith, and wherein the plurality of label sequences corresponded to the k highest confidence levels, where k is a natural number which is fewer than a total number of sequences generated for the sequential data.

17. The at least one computer-readable medium of claim 15 wherein the plurality of label sequences included a highest confidence level sequence for each of the attributes of interest.

18. The at least one computer-readable medium of claim 15 wherein the sequential model comprises one of a Conditional Random Field model, a Hidden Markov model, or a Maximum Entropy Markov model.
